(19) United States
(12) Patent Application Publication
(10) Pub. No.: US 2018/0185678 A1
(43) Pub. Date: Jul. 5, 2018

(54) POLYMER NONWOVEN NANOWEB HAVING IONIC FUNCTIONAL GROUP AND RESPIRATOR MASK COMPRISING THE SAME

(71) Applicant: GWANGJU INSTITUTE OF SCIENCE AND TECHNOLOGY, Gwangju (KR)

(72) Inventors: Jaesuk LEE, Gwangju (KR); Subin LEE, Gwangju (KR); Kihong PARK, Gwangju (KR); Minkyoon AHN, Gwangju (KR); Heejoo CHO, Gwangju (KR); Cheongmin MIN, Gwangju (KR); Kyungseok KANG, Daejeon (KR)

(21) Appl. No.: 15/570,494

(22) PCT Filed: Apr. 29, 2016
(86) PCT No.: PCT/KR2016/004540

§ 371 Date: Dec. 20, 2017

(30) Foreign Application Priority Data
Apr. 30, 2015 (KR) 10-2015-0061166

(51) Int. Cl. A62B 23/02; C08F 220/14; C08F 212/14; C08F 212/08; B01J 41/14; C08G 67/00; B01J 41/13; B01J 39/19; C08F 220/28; C08F 230/02; B01J 39/20; A01N 25/10; A01N 59/16; A01N 59/12; B01D 39/16

(52) U.S. Cl. CPC A62B 23/025; B01D 2239/0618; C08F 212/14; C08F 212/08; B01J 41/14; C08G 67/00; B01J 41/13; B01J 39/19; C08F 220/28; C08F 230/02; B01J 39/20; A01N 25/10; A01N 59/16; A01N 59/12; B01D 39/1623; C08F 2220/281; D10B 2509/00; B01D 2239/0208; B01D 2239/0414; C08F 220/14

(57) ABSTRACT

Polymer nonwoven nanoweb containing ionic functional group and respiratory mask including the same are provided. The polymeric nonwoven web comprises polymer fibers having a diameter in the nanometer range and having a polymer with an ionic functional group in its main chain or side chain. The ionic functional group may be a sulfonate group, an ammonium group, an azanide group, a phosphonate group, a phosphate group, or a zwitterion group having two of these ionic functional groups linked. The polymeric nonwoven web may further comprise a counter ion having a charge of opposite sign to the charge of the ionic functional group, such as Ag⁺ or I⁻.

### TECHNICAL FIELD

Example embodiments of the present invention relate to a nonwoven web, and more specifically to a gas filter.

### BACKGROUND ART

Recently, the concentration of fine dust originating from the substances such as yellow dust from China and the artificial pollution materials such as industrial exhaust gas and automobile exhaust gas are gradually increasing. These fine dusts are classified into PM10 (2.5 μm<diameter≤10 μm) and PM2.5 (diameter≤2.5 μm) according to their diameters. PM2.5 is generally named ultra fine dust and has a diameter of about 0.1 to 2.5 μm. It is known that PM2.5 penetrates deeply into the lungs and is adsorbed to the alveoli and damages the alveoli, thus affecting the prevalence of asthma and lung disease and the increase of the early mortality rate.

Currently developed masks mainly use electret filters such as those disclosed in Korean Patent Publication No. 2012-0006527, for example. Such an electret filter is a filter manufactured by charging the filter in various manners including triboelectric charging, DC corona discharge, or hydrocharging. Such a filter is disadvantageous in that the charging is gradually extinguished by moisture in the air or moisture caused by respiration, and the performance is reduced.

### DISCLOSURE

### Technical Problem

It is an object of example embodiments of the present invention to provide a polymeric nonwoven web in which fine dust filtering efficiency can be improved by moisture generated by breathing.

The technical objects of the present invention are not limited to the above-mentioned technical objects, and other technical objects which are not mentioned can be clearly understood by those skilled in the art from the following description.

### Technical Solution

It is an object of example embodiments of the present invention to provide a polymeric nonwoven web. The polymeric nonwoven web comprises polymer fibers having a diameter in the nanometer range and having a polymer with an ionic functional group in its main chain or side chain.

The ionic functional group may include a sulfonate group, an ammonium group, an azanide group, a phosphate group, or a zwitterion group having two of these combined. The ammonium group may be a quaternary ammonium group. The ionic functional group including the azanide group may be a sulfadiazinyl group. The ionic functional group including the zwitterion group may be a phosphorylcholine group.

The polymeric nonwoven web may further comprises Ag⁺ or I⁻ as a counter ion having a charge of opposite sign to the charge of the ionic functional group.

The polymer may be polystyrene, polymethyl methacrylate, polyarylene ether, polyurethane or a copolymer of two or more thereof. The polymer may be a copolymer of a monomer unit having the ionic functional group and a monomer unit having no ionic functional group. The monomers may be, independently of each other, styrene-based units, methyl methacrylate-based units, arylene ether-based units, or urethane-based units.

The fibers may have a diameter of 100 to 900 nm. The polymeric nonwoven web may be a gas filter.

It is another object of example embodiments of the present invention to provide a process for producing a polymeric nonwoven web. The process comprises electrospinning a polymer having an ionic functional group in its main chain or side chain to produce a nonwoven web formed of polymer fibers having a diameter in the nanometer range.

The ionic functional group may include a sulfonate group, an ammonium group, an azanide group, a phosphate group, or a zwitterion group having two of these combined. The nonwoven web may be immersed in an ion exchange solution to introduce Ag⁺ or I⁻, which is a counter ion having a charge of opposite sign to the charge of the ionic functional group.

It is another object of example embodiments of the present invention to provide a respiratory mask. The respiratory mask comprises a base layer and a cover layer. A polymeric nonwoven web is disposed between the base layer and the cover layer. The polymeric nonwoven web comprises polymer fibers having a diameter in the nanometer range and having a polymer with an ionic functional group in its main chain or side chain.

### Advantageous Effects

According to example embodiments of the present invention, since the polymer constituting the fibers has an ionic functional group, the fine dust can be filtered by the electrostatic attraction. Thus, the size of the pores in the nonwoven web may not be greatly reduced, thereby exhibiting a proper pressure drop value and a good filtering efficiency. Particularly, it is possible to efficiently filter ionic particles contained in fine dust. In addition, the ionization is promoted by the moisture caused by the breath, so that the electrostatic force can be improved, and the electrostatic force can be maintained permanently even when cleaning the polymer nonwoven web.

### DESCRIPTION OF DRAWINGS

Example embodiments of the present invention will become more apparent by describing in detail example embodiments of the present invention with reference to the accompanying drawings, in which:

FIG. 1 is a schematic view of a polymeric nonwoven web according to an embodiment of the present invention;

FIG. 2 is a schematic view showing a cross section of a respiratory mask according to another embodiment of the present invention;

FIG. 3 is a ¹H-NMR (nuclear magnetic resonance) spectrum of the intermediate obtained in Polymer Synthesis Example 1 and measured in a CDCl₃ solvent;

FIG. 4 is a Fourier-transform infrared spectroscopy (FT-IR) graph of Polymer A obtained in Polymer Synthesis Example 1;

FIG. 5 is a ¹H-NMR spectrum of Polymer B obtained in Polymer Synthesis Example 2 and measured in a DMSO-d6 solvent;

FIG. 6 is a Fourier-transform infrared spectroscopy (FT-IR) graph of the polymer B obtained in Polymer Synthesis Example 2;

FIG. 7 is a ¹H-NMR spectrum of Polymer C obtained in Polymer Synthesis Example 3 in dimethyl sulfoxide-d6 solvent;

FIG. 8 is an FT-IR graph of the polymer C obtained in Polymer Synthesis Example 3;

FIGS. 9, 10 and 11 are SEM images of polymer nonwoven webs according to polymeric nonwoven web preparation examples 1, 2, and 3, respectively;

FIG. 12 is a graph showing the results of EDS (Energy Dispersive X-ray Spectroscopy) analysis of the polymeric nonwoven web A according to Antimicrobial polymeric nonwoven web Preparation Example 1;

FIG. 13 is a graph showing the results of EDS analysis of the polymeric nonwoven web B according to Antimicrobial polymeric nonwoven web Preparation Example 2;

FIG. 14 is a graph showing the results of EDS analysis of the polymeric nonwoven web C according to Antimicrobial polymeric nonwoven web Preparation Example 3;

FIG. 15 is a graph showing the dust collection efficiency and the breathing resistance of the filter 1-1, the filter 1-2, and the filter according to the comparative example;

FIG. 16 is a graph showing the dust collection efficiency and the breathing resistance of the filter 2-1, the filter 2-2, and the filter according to the comparative example;

FIG. 17 is a graph showing the dust collection efficiency and the breathing resistance of the filter 3-1, the filter 3-2, and the filter according to the comparative example;

FIGS. 18A and 18B are photographs showing the result of culturing Staphylococcus aureus in the culture medium itself and the polymeric nonwoven web A containing the culture medium, respectively;

FIGS. 19A and 19B are photographs showing the result of culturing pneumococci in the culture medium itself and the polymeric nonwoven web A containing the culture medium, respectively;

FIGS. 20A and 20B are photographs showing the result of culturing Staphylococcus aureus in the culture medium itself and the polymeric nonwoven web B containing the culture medium, respectively;

FIGS. 21A and 21B are photographs showing the result of culturing pneumococci in the culture medium itself and the polymeric nonwoven web B containing the culture medium, respectively;

FIGS. 22A and 22B are photographs showing the result of culturing Staphylococcus aureus in the culture medium itself and the polymeric nonwoven web C containing the culture medium, respectively; and

FIGS. 23A and 23B are photographs showing the result of culturing pneumococci in the culture medium itself and the polymeric nonwoven web C containing the culture medium, respectively.

### MODES OF THE INVENTION

Hereinafter, exemplary embodiments of the present invention will be described in detail with reference to the accompanying drawings. The embodiments to be described below may be modified in several different forms, and the scope of the present invention is not limited to the embodiments.

When a layer is referred to herein as being “on” another layer or substrate, it may be formed directly on another layer or substrate, or a third layer may be interposed therebetween. In the present specification, directional expressions such as on, upper, an upper side, an upper surface, and the like can be understood as meaning beneath, lower, a lower side, a lower surface, and the like. That is, the expression of the spatial direction should be understood in a relative direction, and should not be construed as definitively as an absolute direction.

Further, in the drawings, the thicknesses of the layers and regions are exaggerated for the sake of clarity. Like reference numerals in the drawings denote like elements.

When “Cx to Cy” is described in the present specification, the number of carbon atoms corresponding to all the integers between x and y is also to be interpreted as described.

As used herein, the term “alkyl group” means an aliphatic hydrocarbon group, unless otherwise defined. The alkyl group may be a saturated alkyl group which does not contain any double or triple bonds. Or the alkyl group may be an unsaturated alkyl group comprising at least one double bond or triple bond. The alkyl group, whether saturated or unsaturated, may be branched, straight chain or cyclic. The alkyl group may be a C1 to C4 alkyl group, and specifically, the C1 to C4 alkyl groups may be selected from the group consisting of methyl, ethyl, propyl, iso-propyl, n-butyl, iso-butyl, sec-butyl and t-butyl.

As used herein, unless otherwise defined, the term “alkylene group” means a bivalent atomic group forming by removing one hydrogen atom of the “alkyl group”, which may have a saturated or an unsaturated form.

As used herein, unless otherwise defined, the term “aryl group” means a monocyclic aromatic compound or a polycyclic aromatic compound composed of fused aromatic rings and includes a heteroaryl group.

As used herein, “heteroaryl group”, unless otherwise defined, is a monocyclic aromatic compound or a polycyclic aromatic compound composed of fused aromatic rings, in which at least one ring contains at least one heteroatom selected from the group consisting of N, O, S, Se, and P and the remaining members are all carbon atoms.

As used herein, the term “arylene group” may mean a bivalent atomic group forming by removing one hydrogen atom of the “aryl group”, unless otherwise defined.

In the present specification, the substituent may be an alkyl group, an aryl group, a halogen group, or a hydroxyl group.

As used herein, the term “halogen group” means a group 17 element, for example, F, Cl, Br, or I, unless otherwise defined.

In the present specification, the copolymer may be an alternating copolymer, a block copolymer, or a random copolymer, and the form thereof may be a linear copolymer, a branched copolymer or a network-type copolymer.

Polymer Nonwoven Web

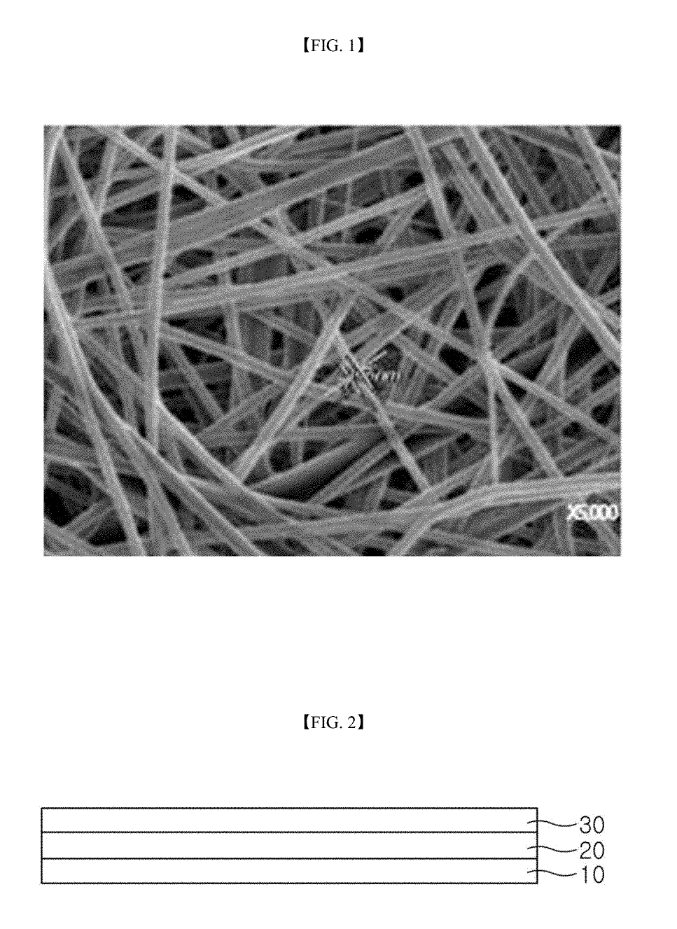

FIG. 1 is a schematic view of a polymeric nonwoven web according to an embodiment of the present invention.

Referring to FIG. 1, the polymeric nonwoven web may be a collection of fibers that have not undergone a woven process. The polymeric nonwoven web may be a fluid filter, in particular a liquid filter or a gas filter. As an example, it may be an air filter, specifically a filter of an automotive air conditioning filter or an air purifier. Further, as an example of the air filter, it may be a filter used for a respirator mask.

The fibers may be nanofibers having diameters in the nanometer range, for example 100 nm to less than 1000 nm. Specifically, the diameter of the fiber may be any value within the above range, but may be, for example, 100 to 900 nm, 200 to 800 nm, 300 to 700 nm, or 400 to 600 nm. In addition, the average size of the pores in the polymeric nonwoven web can be 0.1 μm to 5 μm. The thickness of the polymeric nonwoven web may be as small as several tens of μm, specifically, 30 to 50 μm. However, the present invention is not limited to this, and the thickness of the polymer nonwoven web can be variously changed depending on the use.

Examples of the polymer forming the fiber include Polyolefins such as polystyrene, polymethyl methacrylate, polyethylene, and polypropylene; Polyarylene ethers such as polyphenylene ether; Polyesters such as polyethylene terephthalate, polybutylene terephthalate and polyhydroxycarboxylic acid; Fluorine resins such as PTFE (Polytetrafluoroethylene), CTFE (Chlorotrifluoroethylene), PFA (perfluoroalkoxy alkanes) and polyvinylidene fluoride (PVDF); Halogenated polyolefins such as polyvinyl chloride; Polyamides such as nylon-6 and nylon-66; Urea resins; Phenolic resins; Melamine resins; celluloses; Cellulose acetates; Cellulose nitrates; Polyether ketones; Polyether ketone ketones; Polyether ether ketone; Polysulfone; Polyethersulfones; Polyimides; Polyetherimides; Polyamideimides; Polybenzomidazoles; Polycarbonates; Polyphenylene sulfides; Polyacrylonitriles; Polyether nitriles; and their respective copolymers.

Specifically, the polymer may be polystyrene, polymethyl methacrylate, polyarylene ether, polyurethane, or a copolymer of two or more thereof. Such a polymer may have sufficient mechanical strength to form a nonwoven web. In addition, the polymer may have a molecular weight of 10,000 to 500,000, for example, 50,000 to 300,000.

Such a polymer may have an ionic functional group in its main chain or side chain. Accordingly, the polymer or the nonwoven web may have an ion exchange capacity in the range of 0.01-3.00 meq/g, specifically 0.01-2.00 meq/g. The polymer may be a copolymer of a monomer unit having an ionic functional group and a monomer unit having no ionic functional group in its main chain or side chain. The monomer units may be a styrene type unit, a methyl methacrylate type unit, an arylene ether type unit, or a urethane type unit, regardless of each other. In this case, it is possible to obtain favorable conditions for electrospinning, which will be described later, by controlling the ratio of the monomer unit having an ionic functional group to the monomer unit having no ionic functional group.

When the polymer has an ionic functional group in the side chain, various linking groups may be used between the ionic functional group and the main chain of the polymer. For example, the linking group may be a substituted or unsubstituted C1 to C12 alkylene group, a substituted or unsubstituted C1 to C12 alkylenecarbonyl group, a substituted or unsubstituted C1 to C12 alkylene carboxy group, a substituted or unsubstituted C1 to C12 alkyleneamide group, a substituted or unsubstituted C3 to C12 arylene group, a substituted or unsubstituted C3 to C12 arylene carbonyl group, a substituted or unsubstituted C3 to C12 arylene carboxy group, or a substituted C3 to C12 arylene amide group.

The ionic functional group may includes a sulfonate group (—SO₃⁻), a carboxylate group (—COO⁻), an ammonium group (—NR₃⁺ or —NR₂⁺—; here, a plurality of R may be, independently of each other, hydrogen, a substituted or unsubstituted C1 to C4 alkyl group, or a substituted or unsubstituted C3 to C6 aryl group), an azanide group (—NR⁻ or —N⁻—; here, R may be hydrogen, a substituted or unsubstituted C1 to C4 alkyl group, a substituted or unsubstituted C3 to C6 aryl group, or a sulfonyl group), a phosphonate group (—PO(O⁻)₂ or —PO(OR)O⁻; here, R may be, independently of each other, hydrogen, a substituted or unsubstituted C1 to C4 alkyl group, or a substituted or unsubstituted C3 to C6 aryl group), a phosphate group (—OPO(O⁻)₂ or —OPO(OR)O⁻; here, R may be, independently of each other, hydrogen, a substituted or unsubstituted C1 to C4 alkyl group, or a substituted or unsubstituted C3 to C6 aryl group), or a zwitterion group in which two of those ionic functional groups are bonded directly or indirectly. When the ionic functional group is a zwitterion group, the cation and the anion may be indirectly connected by a linking group, for example, a substituted or unsubstituted C1 to C4 alkyl group.

The ionic functional group may be a functional group which exhibits a relatively high ionization degree and can be ionized by a small amount of moisture such as moisture by respiration and is, for example, a sulfonate group (—SO₃⁻), an ammonium group (—NR₃⁺ or —NR₂⁺—; here, R is, independently of each other, hydrogen, a substituted or unsubstituted C1 to C4 alkyl group, or a substituted or unsubstituted C3 to C6 aryl group), an azanide group (—NR⁻ or —N⁻—; here, R is hydrogen, a substituted or unsubstituted C1 to C4 alkyl group, a substituted or unsubstituted C3 to C6 aryl group, or a sulfonyl group), a phosphate group (—OPO(O⁻)₂ or —OPO(OR)O⁻; here, R is, independently of each other, hydrogen, a substituted or unsubstituted C1 to C4 alkyl group, or a substituted or unsubstituted C3 to C6 aryl group), or a zwitterion group in which two of those ionic functional groups are bonded directly or indirectly. The ammonium group may be a quaternary ammonium group (—NR₃⁺ or —NR₂⁺—; here, R is, independently of each other, a substituted or unsubstituted C1 to C4 alkyl group, or a substituted or unsubstituted C3 to C6 aryl group). The ionic functional group including the azanide group may be a sulfadiazinyl group having antimicrobial activity. The ammonium group may also exhibit antibacterial activity. The ionic functional group including the zwitterion group may be a phosphorylcholine group having a phosphate group and a quaternary ammonium group.

These ionic functional groups can serve to filter fine dusts by electrostatic attraction. In the turbid air, there may be PM10 (2.5 μm<particle diameter≤10 μm) which is referred to as fine dust and PM2.5 (particle diameter≤2.5 μm) which is referred to as ultra fine dust. Conventional filters physically filter particles by having pores with a size smaller than the diameter of the particles. Recently, the size of the pores must be very small in order to filter fine particles such as fine dust or ultra fine dust particles. In this case, the pressure drop across the filter becomes too large, so that when the filter is used as a fluid filter, the power consumption becomes large, or when the filter is used as a breathing mask, the user's breathing may become difficult. However, in the case of the polymeric nonwoven web according to the present embodiment, since the polymer has an ionic functional group and the fine dust is filtered by the electrostatic attraction, the size of the pores in the web may not be greatly reduced. Thus, it is possible to exhibit a good filtering efficiency while exhibiting an appropriate pressure drop value. Particularly, it is known that fine dusts contain ionic particles such as nitrogen oxides (NOx), sulfur oxides (SOx), and ammonium salts (NHx) in an amount of 50% or more. Polymeric nonwoven webs can efficiently filter these ionic particles by electrostatic attraction. In addition, the polymeric nonwoven web according to this embodiment can also efficiently filter ionic particles in the liquid.

In addition, the electret filter to which charge is imparted by the conventional charging technique can lose the electrostatic force due to moisture. On the other hand, since the polymeric nonwoven web according to the present embodiment contains an ionic functional group, particularly an ionic functional group having the relatively high ionization degree, ionization is promoted by moisture caused by respiration, so that the electrostatic force of the polymeric nonwoven web can be improved by respiration unlike the electret filter. In addition, even when cleaning the web repeatedly, the electrostatic force can be maintained permanently.

Further, the polymer may further comprise, in addition to the ionic functional group, a counter ion having a charge of opposite sign to the charge of the ionic functional group. The counterion may be H⁺, Ag⁺, Cl⁻, Br or I⁻. Further, the counterion may be Ag⁺ or I⁻, which may have antibacterial activity. When the antibacterial nanoparticles (eg, silver nanoparticles) are additionally added to the nonwoven web, the antibacterial nanoparticles may be leaked from the nonwoven web. However, in this embodiment, the ionic functional group or the counterion which has antibacterial activity may not leak from the nonwoven web. In addition, the ionic functional groups and/or counter ions can have the advantage that the antimicrobial activity can be more easily activated by the breathing of the user or the moisture contained in the air.

Such a polymer may be any one of the following formulas (1) to (3). The following polymers may, for example, have a molecular weight of 10,000 to 500,000, for example of 50,000 to 300,000.

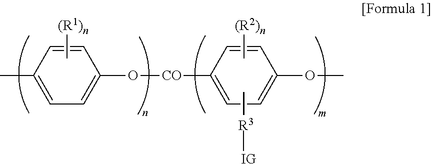

In Formula 1,

n may be an integer of 0 to 10000, m may be an integer of 2 to 10000, 11 may be an integer of 1 to 4, I₂ may be an integer of 1 to 3,

R¹ may be, independently of each other, hydrogen, a substituted or unsubstituted C1 to C4 alkyl group, or a substituted or unsubstituted C3 to C12 aryl group,

R² may be, independently of each other, hydrogen, a substituted or unsubstituted C1 to C4 alkyl group, or a substituted or unsubstituted C3 to C12 aryl group,

R³ may represent a bond, a carbonyl group, a carboxy group, an amide group, a substituted or unsubstituted C1 to C12 alkylene group, a substituted or unsubstituted C1 to C12 alkylenecarbonyl group, a substituted or unsubstituted C1 to C12 carbonylalkylene group, a substituted or unsubstituted C1 to C12 alkylene carboxy group, a substituted or unsubstituted C1 to C12 carboxyalkylene group, a substituted or unsubstituted C1 to C12 alkylene amide group, a substituted or unsubstituted C1 to C12 amide alkylene group, a substituted or unsubstituted C3 to C12 arylene group, a substituted or unsubstituted C3 to C12 arylene carbonyl group, a substituted or unsubstituted C3 to C12 carbonyl arylene group, a substituted or unsubstituted C3 to C12 arylenecarboxy group, a substituted or unsubstituted C3 to C12 carboxyarylene group, a substituted or unsubstituted C3 to C12 arylene amide group, a substituted or unsubstituted C3 to C12 amide arylene group, a substituted or unsubstituted C4 to C12 arylene alkyl group, or a substituted or unsubstituted C4 to C12 alkylene aryl group.

The IG may be a group containing an ionic functional group and specifically includes a sulfonate group, a carboxylate group, an ammonium group, an azanide group, a phosphonate group, a phosphate group, or a zwitter ionic group in which two of those ionic functional groups are bonded directly or indirectly. The IG may further comprise a counter ion having a charge of opposite sign to the charge of the ionic functional group.

The repeating unit represented by the formula 1 may be represented by the following formula 1A or 1B.

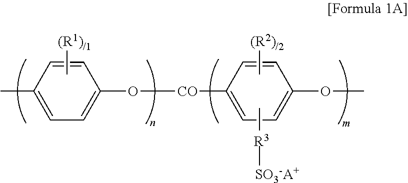

In Formula 1A, n, m, l₁, l₂, R¹, R², and R³ may be the same as defined in Formula 1, and A⁺ may be absent, H⁺, or Ag⁺.

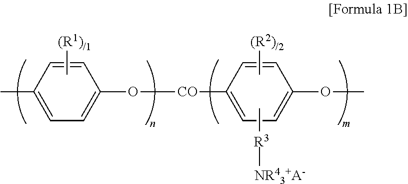

In Formula 1B, n, m, l₁, l₂, R¹, R², and R³ may be the same as defined in Formula 1, a plurality of R⁴ may be, independently of each other, a substituted or unsubstituted C1 to C4 alkyl group, and A⁻ may be absent, Cl⁻, Br⁻, or I⁻.

A specific example of the polymer of formula 1A may be a polymer represented by the following formula 1A_1.

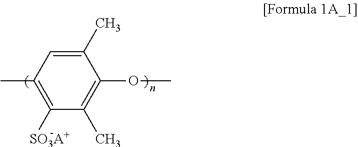

In Formula 1A_1, n and A⁺ may be the same as defined in Formula 1A.

Specific examples of the polymer of Formula 1B may be a polymer represented by the following Formula 1B_1, Formula 1B_2, or Formula 1B_3.

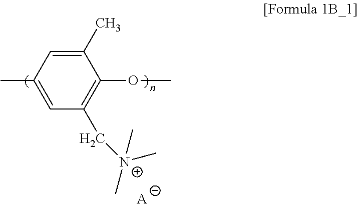

In the above formula 1B_1, n and A⁻ may be the same as defined in the above formula 1B.

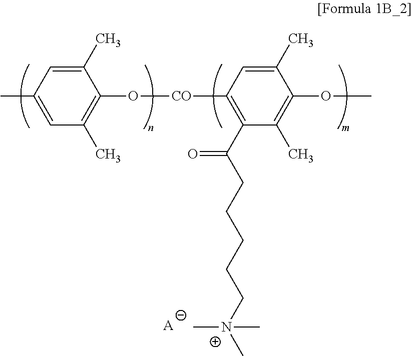

In the above formula 1B_2, n, m, and A⁻ may be the same as defined in the above formula 1B.

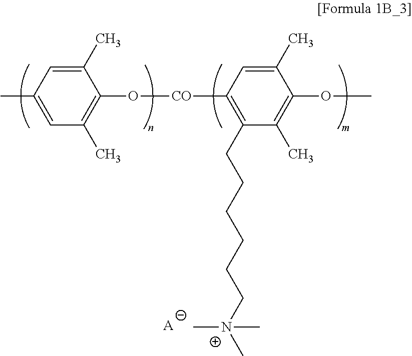

In the above formula 1B_3, n, m, and A⁻ may be the same as defined in the above formula 1B.

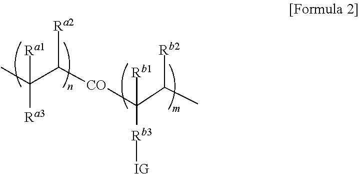

In Formula 2,

n may be an integer of 0 to 10000,

m may be an integer of 2 to 10000,

R^{a1}, R^{a2}, R^{b1}, and R^{b2} may be, independently of each other, hydrogen, a substituted or unsubstituted C1 to C12 alkyl group, or a substituted or unsubstituted C3 to C12 aryl group,

R¹ may be a substituted or unsubstituted C1 to C12 alkyl group, a substituted or unsubstituted C3 to C12 aryl group, or a substituted or unsubstituted C1 to C12 alkylcarboxy group. The substituted C1 to C12 alkyl carboxy group may be a C1 to C12 hydroxyalkyl carboxy group.

R^{b3} may represent a bond, a carbonyl group, a carboxy group, an amide group, a substituted or unsubstituted C1 to C12 alkylene group, a substituted or unsubstituted C1 to C12 alkylenecarbonyl group, a substituted or unsubstituted C1 to C12 carbonylalkylene group, a substituted or unsubstituted C1 to C12 alkylene carboxy group, a substituted or unsubstituted C1 to C12 carboxyalkylene group, a substituted or unsubstituted C1 to C12 alkylene amide group, a substituted or unsubstituted C1 to C12 amide alkylene group, a substituted or unsubstituted C3 to C12 arylene group, a substituted or unsubstituted C3 to C12 arylene carbonyl group, a substituted or unsubstituted C3 to C12 carbonyl arylene group, a substituted or unsubstituted C3 to C12 arylenecarboxy group, a substituted or unsubstituted C3 to C12 carboxyarylene group, a substituted or unsubstituted C3 to C12 arylene amide group, a substituted or unsubstituted C3 to C12 amide arylene group, a substituted or unsubstituted C4 to C12 arylene alkyl group, or a substituted or unsubstituted C4 to C12 alkylene aryl group.

The IG may be a group containing an ionic functional group and specifically includes a sulfonate group, a carboxylate group, an ammonium group, an azanide group, a phosphonate group, a phosphate group, or a zwitter ionic group in which two of those ionic functional groups are bonded. The IG may further comprise a counter ion having a charge of opposite sign to the charge of the ionic functional group.

The polymer of Formula 2 may be represented by Formula 2A below.

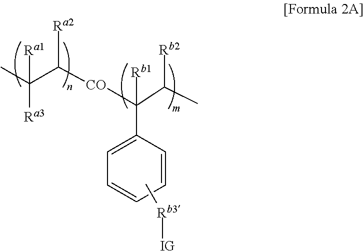

In Formula 2A,

n, m, R^{a1}, R^{a2}, R^{a3}, R^{b1}, R^{b2}, and IG may be the same as defined in Formula 2, R^{b3′} may be a bond, a carbonyl group, a carboxy group, an amide group, a substituted or unsubstituted C1 to C6 alkylene group, or a substituted or unsubstituted C3 to C6 arylene group.

The polymer of Formula 2A may be a polymer represented by following Formula 2A_1, 2A_2, 2A_3, or 2A_4.

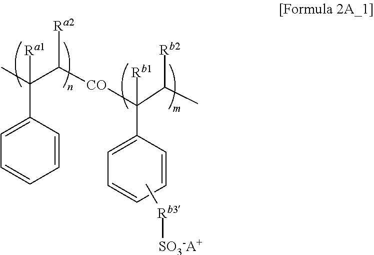

In Formula 2A_1,

n, m, R^{a1}, R^{a2}, R^{b1}, R^{b2}, and R^{b3′} may be the same as defined in Formula 2A, and A⁺ may be absent, H⁺ or Ag⁺.

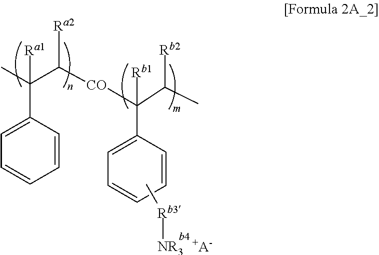

In Formula 2A_2, n, m, R^{a1}, R^{a2}, R^{b1}, R^{b2}, and R^{b3′} may be the same as defined in Formula 2A, a plurality of R^{b4} may be, independently of each other, a substituted or unsubstituted C1 to C4 alkyl group, and A⁻ may be absent, Cl⁻, Br⁻, or I⁻.

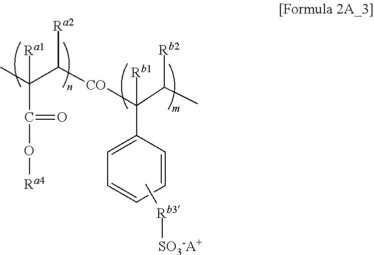

In Formula 2A_3,

n, m, R^{a1}, R^{a2}, R^{b1}, R^{b2}, and R^{b3′} may be the same as defined in Formula 2A, R^{a4} is a substituted or unsubstituted C1 to C12 alkyl group, for example, a C1 to C12 hydroxyalkyl group, and A⁺ may be absent, H⁻ or Ag⁺.

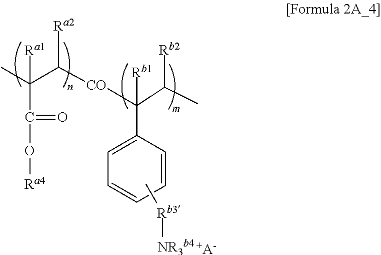

In Formula 2A_4,

n, m, R^{a1}, R^{a2}, R^{b1}, R^{b2}, and R^{b3′} may be the same as defined in Formula 2A, R^{a4} is a substituted or unsubstituted C1 to C12 alkyl group, for example, a C1 to C12 hydroxyalkyl group, a plurality of R^{b4} may be, independently of each other, a substituted or unsubstituted C1 to C4 alkyl group, and A⁻ may be absent, Cl⁻, Br⁻, or I⁻.

The polymer of Formula 2 may be represented by the following Formula 2B or Formula 2C.

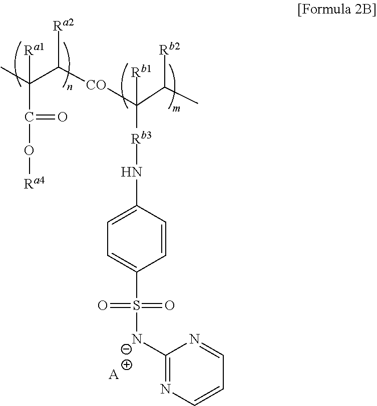

In Formula 2B,

n, m, R^{a1}, R^{a2}, R^{b1}, R^{b2}, and R^{b3} may be the same as defined in Formula 2, R^{a4} is a substituted or unsubstituted C1 to C12 alkyl group, for example, a C1 to C12 hydroxyalkyl group, and A⁺ may be Ag⁺.

Specific examples of the polymer of Formula 2B may be a polymer of Formula 2B_1.

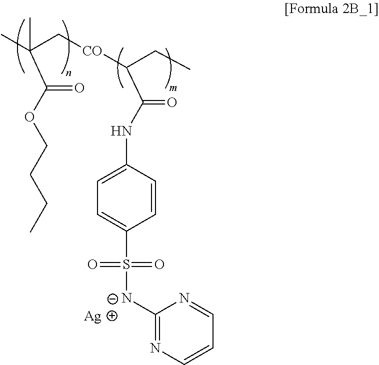

In Formula 2B_1, n and m may be the same as defined in Formula 2B above.

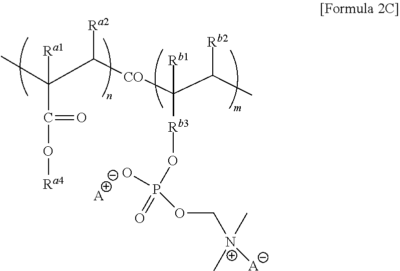

In Formula 2C,

n, m, R^{a1}, R^{a2}, R^{b1}, R^{b2}, and R^{b3} may be the same as defined in Formula 2, R^{a4} is a substituted or unsubstituted C1 to C12 alkyl group, for example, a C1 to C12 hydroxyalkyl group, A⁺ may be absent, H⁺ or Ag⁺, and A⁻ may be absent, Cl⁻, Br⁻, or I⁻.

Specific examples of the polymer of Formula 2C may be a polymer of Formula 2C_1.

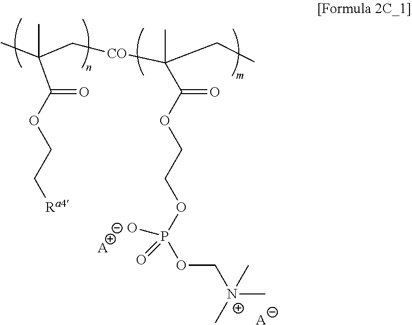

In Formula 2C_1, n, m, A⁺, and A⁻ may be the same as defined in Formula 2C, and R^{a4′} may be an ethyl group or a hydroxy group.

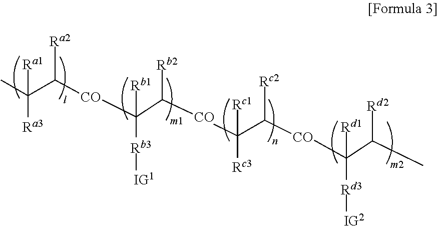

In Formula 3,

l may be an integer of 0 to 10000,

n may be an integer of 1 to 10000,

m1 and m2 may be integers satisfying the condition that m1+m2 is 1 to 10000,

R^{a1}, R^{a2}, R^{b1}, R^{b2}, R^{c1}, R^{c2}, R^{d1}, and R^{d2} may be, independently of each other, hydrogen, a substituted or unsubstituted C1 to C12 alkyl group, or a substituted or unsubstituted C3 to C12 aryl group,

R^{a3} and R^{c3} may be, independently of each other, a substituted or unsubstituted C1 to C12 alkyl group, a substituted or unsubstituted C3 to C12 aryl group, or a substituted or unsubstituted C1 to C12 alkylcarboxy group, and

R^{b3} and R^{d3} may represent, independently of each other, a bond, a carbonyl group, a carboxy group, an amide group, a substituted or unsubstituted C1 to C12 alkylene group, a substituted or unsubstituted C1 to C12 alkylenecarbonyl group, a substituted or unsubstituted C1 to C12 carbonylalkylene group, a substituted or unsubstituted C1 to C12 alkylene carboxy group, a substituted or unsubstituted C1 to C12 carboxyalkylene group, a substituted or unsubstituted C1 to C12 alkylene amide group, a substituted or unsubstituted C1 to C12 amide alkylene group, a substituted or unsubstituted C3 to C12 arylene group, a substituted or unsubstituted C3 to C12 arylene carbonyl group, a substituted or unsubstituted C3 to C12 carbonyl arylene group, a substituted or unsubstituted C3 to C12 arylenecarboxy group, a substituted or unsubstituted C3 to C12 carboxyarylene group, a substituted or unsubstituted C3 to C12 arylene amide group, a substituted or unsubstituted C3 to C12 amide arylene group, a substituted or unsubstituted C4 to C12 arylene alkyl group, or a substituted or unsubstituted C4 to C12 alkylene aryl group.

The IG¹ and IG² may be groups each containing an ionic functional group and specifically includes, independently of each other, a sulfonate group, a carboxylate group, an ammonium group, an azanide group, a phosphonate group, a phosphate group, or a zwitter ionic group in which two of those ionic groups are bonded. The IG¹ and IG² may further comprise counter ions having a charge of opposite sign to the charge of the ionic functional group.

The polymer of Formula 3 may be represented by Formula 3A below.

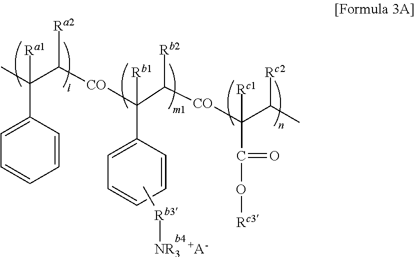

In Formula 3A,

l, n, m1, m2, R^{a1}, R^{a2}, R^{b1}, R^{b2}, R^{c1}, and R^{c2} may be the same as defined in Formula 3, R^{b3′} may be a bond, a carbonyl group, a carboxy group, an amide group, a substituted or unsubstituted C1 to C6 alkylene group, or a substituted or unsubstituted C3 to C6 arylene group, R^{c3′} may be a substituted or unsubstituted C1 to C12 alkyl group, a plurality of R^{b4} may be, independently of each other, a substituted or unsubstituted C1 to C4 alkyl group, and A⁻ may be absent, Cl⁻, Br⁻, or I⁻.

The preparation of such a polymeric nonwoven web can be carried out using electrospinning. Specifically, after dissolving one of the polymers in a solvent to prepare a spinning solution, the spinning solution may be placed in a syringe connected to a needle, and an electric field may be applied between the needle and a collector to electrospin fibers onto the collector. By such electrospinning, nanofibers having a diameter of 100 nm or more and less than 1000 nm can be randomly entangled to form a nonwoven web.

In such electrospinning, electrospinning of a polymer having an ionic functional group may be somewhat difficult. Therefore, a copolymer of a monomer unit having an ionic functional group and a monomer unit having no ionic functional group can be used (n is an integer of 1 or more in the formula 1 or 2, and the sum of 1 and n is an integer of 1 or more in the formula 3). In addition, the ratio of the ionic functional group-containing monomer unit to the ionic functional group-free monomer unit can be adjusted to facilitate the electrospinning. As an example, in Formula 3, l:m1+m2:n may be about 1:1:2, and specifically, l:m1:n in Formula 3A may be about 1:1:2. On the other hand, in the formula 2 or 1, n:m may be 7:3, specifically, n:m in the formula 2c_1 may be 7:3.

Further, after a non-woven web is formed by electrospinning a polymer having an ionic functional group, the nonwoven web may be immersed in an ion exchange solution, for example, AgNO₃ or KI solution to introduce a counter ion of Ag⁺ or I⁻ into the polymer in the nonwoven web.

In addition to or apart from the counterion introduction, the nonwoven web may be heat treated or ultraviolet treated, or after an additional crosslinking agent is introduced into the nonwoven web, crosslinking may be carried out. In this case, the mechanical strength of the nonwoven web can be further improved.

Respirator Masks

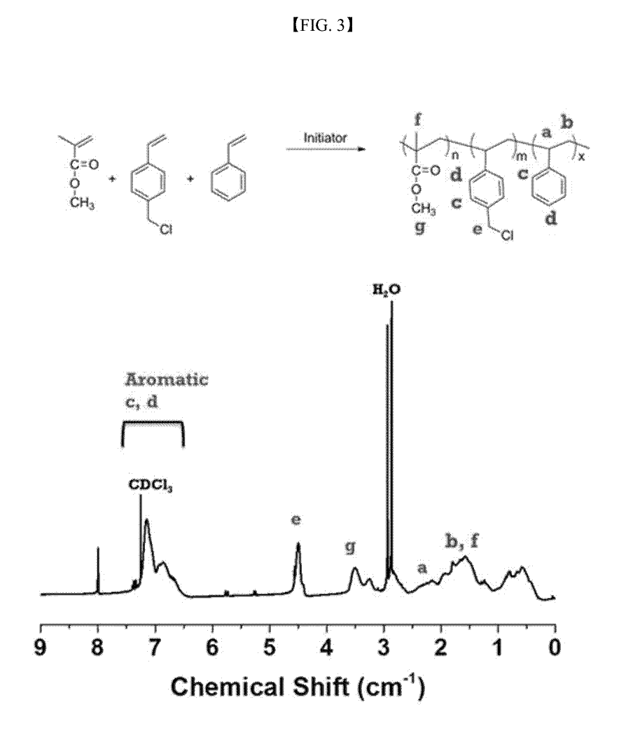

FIG. 2 is a schematic view showing a cross section of a respiratory mask according to another embodiment of the present invention. Specifically, FIG. 2 shows only the filter member in the respiratory mask. The respiratory mask according to this embodiment may be a respiratory protective device covering the nose and mouth of a user and may be a dust-proof mask, a yellow dust mask, a fine dust mask, or the like.

Referring to FIG. 2, the respiratory mask may comprise a base layer 10, a cover layer 30, and a polymeric nonwoven web 20 disposed therebetween. The polymeric nonwoven web 20 may be a polymeric nonwoven web as described above. The polymeric nonwoven web 20 may be a layer formed by electrospinning a polymer on the base layer 10.

One of the base layer 10 and the cover layer 30 may be an inner layer touching the user's skin and the other may be an outer layer exposed to the outside. Specifically, the cover layer 30 may be the inner layer, and the base layer 10 may be the outer layer. The inner layer may be a nonwoven fabric formed of natural fibers or synthetic fibers having low skin irritation and excellent breathability. On the other hand, the outer layer may be formed of the same material as the inner skin layer, or may be a nonwoven fabric having mechanical strength sufficient to protect the polymeric nonwoven web 20, which may be formed of synthetic fibers, for example, polyethylene terephthalate, polyethylene fibers or polypropylene fibers.

The fibers constituting the base layer 10 and the cover layer 30 may have a diameter in the unit of micrometers. Thus, particles may also be filtered in the base layer 10 and the cover layer 30, but in the case of fine dusts, they may be mainly filtered in the polymeric nonwoven web 20.

Hereinafter, exemplary embodiments of the present invention will be described in order to facilitate understanding of the present invention. It should be understood, however, that the following examples are for the purpose of promoting understanding of the present invention and are not intended to limit the scope of the present invention.

### EXAMPLES

### Polymer Synthesis Example 1: Polymer A

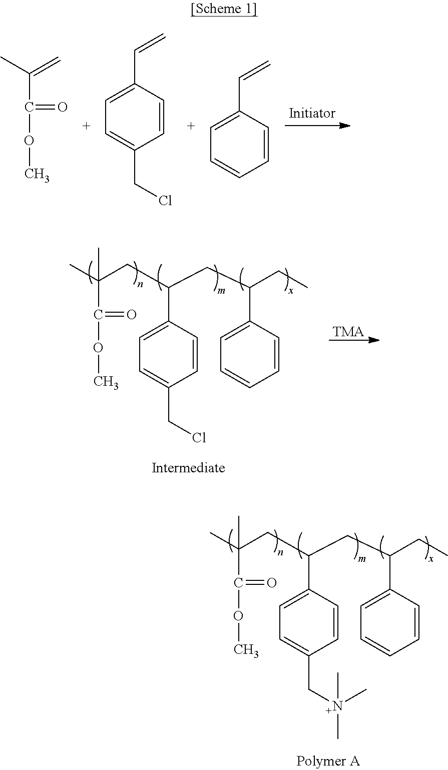

MMA (methyl methacrylate), VBC (vinylbenzyl chloride), and styrene were dissolved in toluene, and a polymerization initiator (benzoyl peroxide) was added thereto. After radical polymerization, the obtained co-polymer was precipitated, washed and dried in an oven at 60° C. to obtain an intermediate. The co-polymer was subjected to an amine reaction with TMA (trimethyl amine) to obtain Polymer A (number average molecular weight: 200,000 to 300,000, ion exchange capacity: 1.40 meq/g).

FIG. 3 is a ¹H-NMR (nuclear magnetic resonance) spectrum of the intermediate obtained in Polymer Synthesis Example 1 and measured in a CDCl₃ solvent.

Referring to FIG. 3, the peaks a to g shown in the ¹H-NMR spectrum may confirm that the intermediate is synthesized.

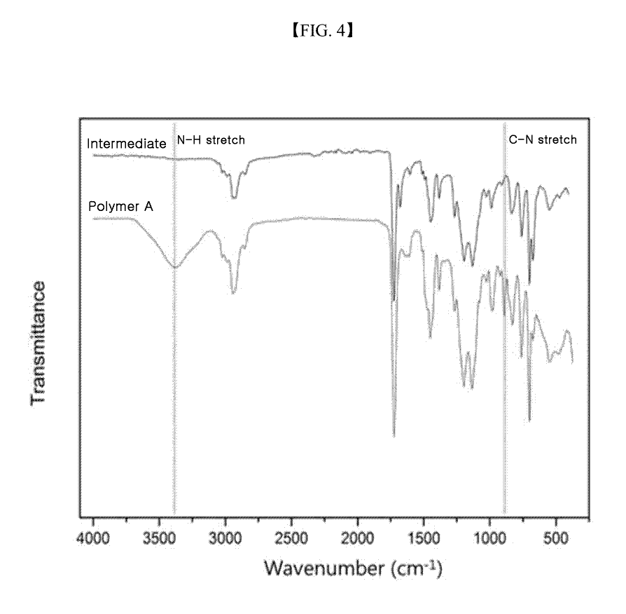

FIG. 4 is a Fourier-transform infrared spectroscopy (FT-IR) graph of Polymer A obtained in Polymer Synthesis Example 1.

Referring to FIG. 4, the N—H stretch vibration and the C—N stretching vibration-related peaks are confirmed, and it can be confirmed that the polymer A is synthesized.

### Polymer Synthesis Example 2: Polymer B

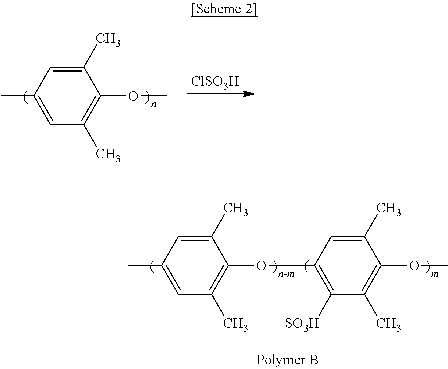

PPO (polyphenylene oxide) was dissolved in chloroform. Chlorosulfonic acid was slowly added dropwise to the PPO solution. Polymer B synthesized by the reaction was obtained through precipitation. Polymer B was washed with deionized water, filtered, and then dried in an oven at 60° C. for more than 24 hours. (Number average molecular weight: 50,000 to 60,000, ion exchange capacity: 1.70 meq/g).

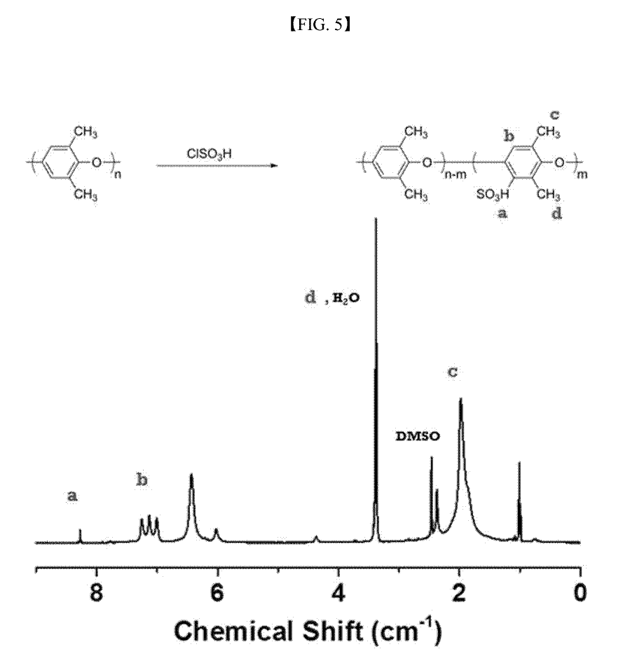

FIG. 5 is a ¹H-NMR spectrum of Polymer B obtained in Polymer Synthesis Example 2 and measured in a DMSO-d6 solvent.

Referring to FIG. 5, it was confirmed that the polymer B was synthesized by confirming the peak a indicating the sulfonic acid group shown in the ¹H-NMR spectrum.

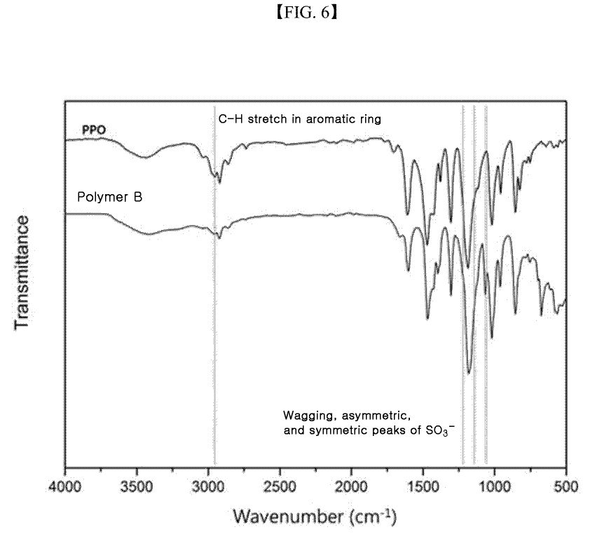

FIG. 6 is a Fourier-transform infrared spectroscopy (FT-IR) graph of the polymer B obtained in Polymer Synthesis Example 2.

Referring to FIG. 6, it can be confirmed that the polymer B was synthesized by confirming the wagging, asymmetric stretching vibration, and symmetric stretching vibration related peaks of the sulfonic acid group.

### Polymer Synthesis Example 3: Polymer C

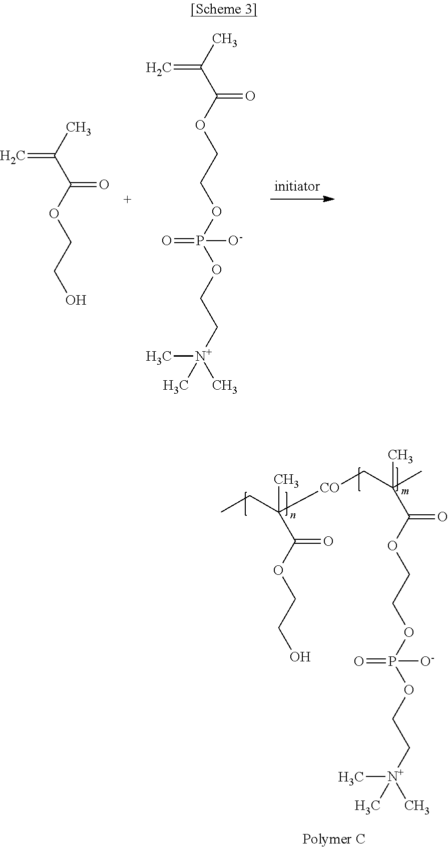

7 g (53.78 mmol) of HEMA (hydroxyethyl methacrylate) and 3 g (10.16 mmol) of MPC (2-methacryloyloxyethyl phosphorylcholine) were dissolved in 30 ml of deionized water and 0.639 mmol of VA-044 (2,2′-Azobis[2-(2-imidazolin-2-yl)propane] dihydrochloride) as a polymerization initiator was added thereto. The resultant was reacted at 70° C. for 1 hour to obtain a co-polymer, and the resulting co-polymer was dried in an oven at 40° C. to obtain a poly(HEMA-co-MPC) polymer, that is, a polymer C (molecular weight of 20,000 to 100,000 in number average molecular weight, ion exchange capacity of 1.67 meq/g).

FIG. 7 is a ¹H-NMR spectrum of Polymer C obtained in Polymer Synthesis Example 3 in dimethyl sulfoxide-d6 solvent.

Referring to FIG. 7, the peaks a to j shown on the ¹H-NMR graph can be confirmed. Also, it can be confirmed that the n:m of the polymer C is 7:3 through the integral value of the e-peak and the i-peak.

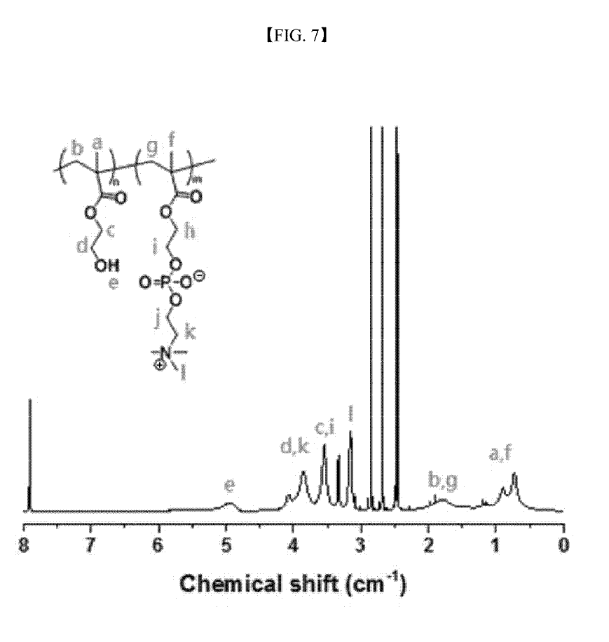

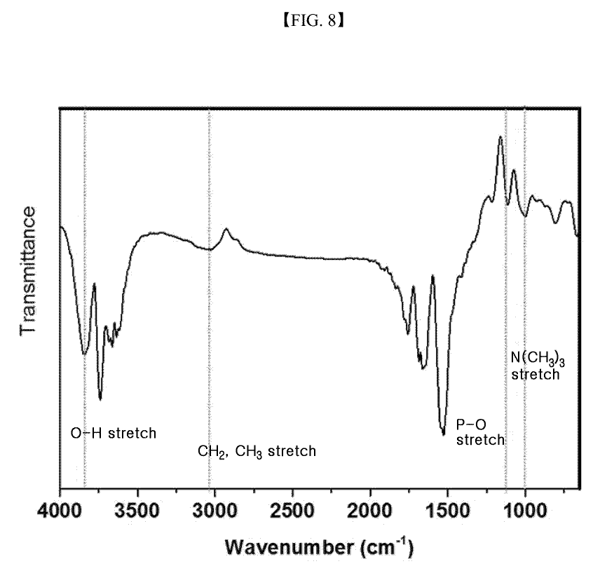

FIG. 8 is an FT-IR graph of the polymer C obtained in Polymer Synthesis Example 3.

Referring to FIG. 8, it can be confirmed that Polymer C was synthesized as P—O stretch vibration and N(CH₃)₃ stretching vibration related peaks were confirmed.

### Polymeric Nonwoven Web Preparation Example 1: Polymer Nonwoven Web A

Polymer A obtained in Polymer Synthesis Example 1 was dissolved in DMAc at a concentration of 20 wt % to obtain a spinning solution. This spinning solution was filled into the syringe of the spinning device. A 23 gauge needle was attached to the syringe. After the base layer (PET) was placed on the collector of the spinning device, a bias potential of 13 kV was applied between the needle and the collector using a voltage power supply and the spinning solution was electrospun onto the base layer at a rate of 0.6 mL/h to form a polymeric nonwoven web A having a thickness of about 40 μm.

### Polymeric Nonwoven Web Preparation Example 2: Polymer Nonwoven Web B

Polymer B obtained in Polymer Synthesis Example 2 was dissolved in DMAc at a concentration of 20 wt % to obtain a spinning solution. This spinning solution was filled into the syringe of the spinning device. A 23 gauge needle was connected to the syringe. After the base layer (PET) was placed on the collector of the spinning device, a bias potential of 15 kV was applied between the needle and the collector using a power supply, and the spinning solution was electrospun on the base layer at a rate of 0.9 mL/h to form a polymeric nonwoven web B having a thickness of about 40 μm.

### Polymeric Nonwoven Web Preparation Example 3: Polymer Nonwoven Web C

Polymer C obtained in Polymer Synthesis Example 3 was dissolved in DMF (dimethylformamide) at a concentration of 20 wt % to obtain a spinning solution. This spinning solution was filled into the syringe of the spinning device. A 23 gauge needle was connected to the syringe. After the base layer (PET) was placed on the collector of the spinning device, a bias potential of 10 kV was applied between the needle and the collector using a power supply, and the spinning solution was electrospun on the base layer at a rate of 0.3 mL/h to form a polymeric nonwoven web C having a thickness of about 40 μm.

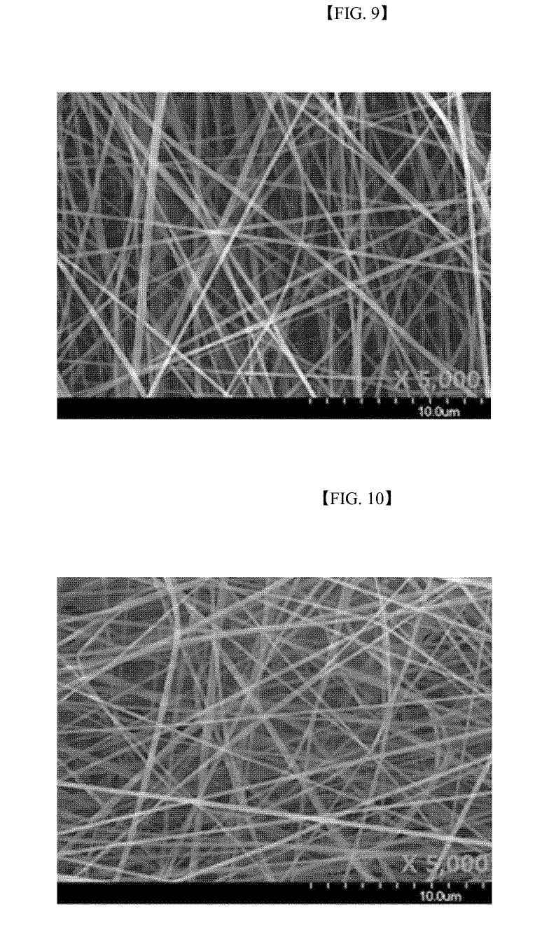

FIGS. 9, 10 and 11 are SEM images of polymer nonwoven webs according to polymeric nonwoven web preparation examples 1, 2, and 3, respectively.

Referring to FIGS. 9, 10 and 11, it can be seen that the polymeric nonwoven webs according to Polymeric nonwoven web Preparation Examples 1, 2, and 3 have fibers having a diameter of 400 to 600 nm.

### Antimicrobial Polymeric Nonwoven Web Preparation Example 1: Polymeric Nonwoven Web a with I⁻ Ion Introduced

The polymeric nonwoven web A according to Polymeric nonwoven web Preparation Example 1 was immersed in an ion exchange solution (0.1 M KI solution) for 24 hours to combine I⁻ ion with the quaternary amine cation of the polymeric nonwoven web A. The excess ion exchange solution remaining in the nonwoven web was then removed by immersion in purified water for 24 hours and dried in an oven at 30° C.

### Antimicrobial Polymeric Nonwoven Web Preparation Example 2: Polymeric Nonwoven Web B with Ag⁺ Ion Introduced

The polymeric nonwoven web B according to Polymeric nonwoven web Preparation Example 2 was immersed in an ion exchange solution (0.1 M AgNO₃ solution) for 24 hours to combine Ag⁺ ion with the sulfonic acid anion of the polymeric nonwoven web B. The excess ion exchange solution remaining in the nonwoven web was then removed by immersion in purified water for 24 hours and dried in an oven at 30° C.

### Antimicrobial Polymeric Nonwoven Web Preparation Example 3: Polymeric Nonwoven Web C with Ag⁺ Ion Introduced

The polymeric nonwoven web C according to Polymeric nonwoven web Preparation Example 3 was immersed in an ion exchange solution (0.1 M AgNO₃ solution) for 24 hours to combine Ag⁺ ion with the phosphate anion of the polymeric nonwoven web C. The excess ion exchange solution remaining in the nonwoven web was then removed by immersion in purified water for 24 hours and dried in an oven at 30° C.

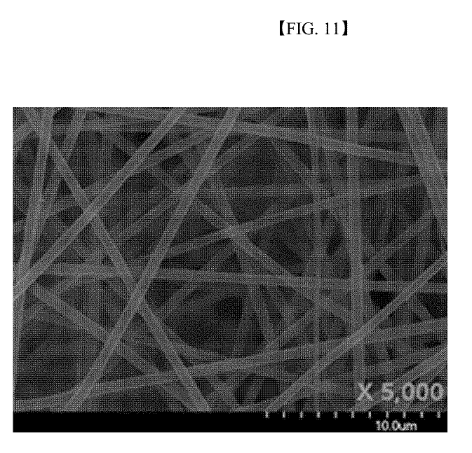

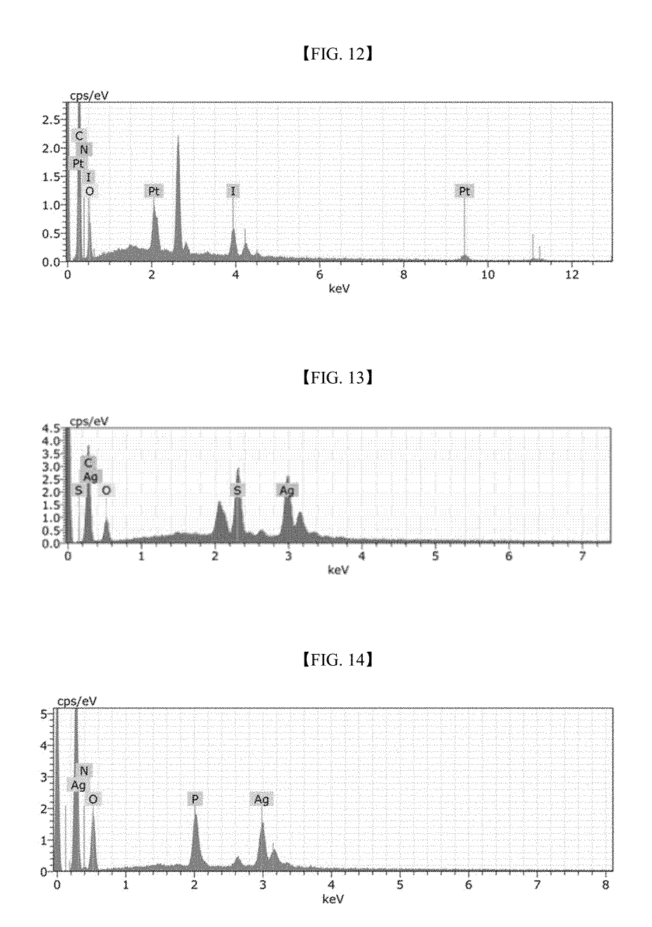

FIG. 12 is a graph showing the results of EDS (Energy Dispersive X-ray Spectroscopy) analysis of the polymeric nonwoven web A according to Antimicrobial polymeric nonwoven web Preparation Example 1, FIG. 13 is a graph showing the results of EDS analysis of the polymeric nonwoven web B according to Antimicrobial polymeric nonwoven web Preparation Example 2, and FIG. 14 is a graph showing the results of EDS analysis of the polymeric nonwoven web C according to Antimicrobial polymeric nonwoven web Preparation Example 3.

Referring to FIGS. 12, 13, and 14, it can be seen that I⁻ ion is successfully introduced into the polymeric nonwoven web A, Ag⁺ ion is successfully introduced into the polymeric nonwoven web B, and Ag⁺ ion is successfully introduced into the polymeric nonwoven web C.

<Performance Evaluation Examples>

Preparation of Test Mask

Filters 1-1 and 1-2 having different packing densities were prepared from the polymeric nonwoven web Preparation Example 1, filters 2-1 and 2-2 having different filling densities were prepared from the polymeric nonwoven web Preparation Example 2, and filters 3-1 and 3-2 having different filling densities were prepared from the polymeric nonwoven web Preparation Example 3. Here, the filling density means the density of the fibers filled on the base layer. Test masks were prepared by attaching a cover layer (PET) to each of the filters. The filters differ in air permeability values according to the difference in filling density (shown in the following Tables). On the other hand, the base layers used in the Polymer non-woven web Preparation examples and the cover layers have pores large enough not to affect the dust collection efficiency or the breathing resistance below.

Dust Collection Efficiency Measurement Example

The 1 wt % sodium chloride solution was injected into the Constant output atomizer (TSI) at a constant rate through a syringe pump to produce droplets in consideration of the standard for the yellow-dust mask prescribed by the Korea Food and Drug Administration and the standard for the theoretical MPPS (Most Penetrating Particle Size). Thereafter, the droplets were passed through a diffusion drier to remove moisture, and only the pure sodium chloride particles were passed through a DMA (differential mobility analyzer, TSI3080, TSI) to produce aerosols of a certain size by adjusting the voltage of the DMA. The diameter of the aerosol particles was fixed at 600 nm, 300 nm, or 200 nm. Such particles can be classified into ultrafine dust (diameter≤1 μm) when viewed in their diameters.

The flow rate through the test mask was also similar to human respiration, i.e., 20 LPM (liter per minute). At this time, except for the aerosol flow rate of 1 LPM, the remaining amount of clean air was 19 LPM in which both moisture and particles were removed.

The number of particles before and after passing through the test mask was measured using a condensation particle counter (TSI3772, TSI).

Example of Measurement of Breathing Resistance

The test mask was put on the test head, and then the pressure drop value (unit: mmH₂O) was measured when 30 LPM of clean air in which both water and particles were removed was passed at a continuous flow rate.

Table 1 below shows the air permeability, the dust collection efficiency, and the breathing resistance of the filter 1-1, the filter 1-2, and the filter according to the comparative example. Both of filters 1-1 and 1-2 are filters prepared by polymeric nonwoven webs according to Polymeric nonwoven web Preparation Example 1 but have different packing densities, that is, air permeability.

TABLE 1

| | | comparative | | |
|---|---|---|---|---|
| | | example | filter 1-1 | filter 1-2 |
| Polymer Type | | — | polymer A | polymer A |
| Air Permeability (cfm@125 Pa) | | — | 15 | 5 |
| Pore Size (μm) | | — | 1.5 | 1.0 |
| Dust collection | 100 nm | 82.554 | 82.286 | 89.477 |
| Efficiency (%) | 200 nm | 78.238 | 96.384 | 98.630 |
| | 300 nm | 84.937 | 99.124 | 99.751 |

| | | | |
|---|---|---|---|
| Breathing Resistance (mmH₂O) | 5 | 1 | 2 |

Table 2 below shows the air permeability, the dust collection efficiency, and the breathing resistance of the filter 2-1, the filter 2-2, and the filter according to the comparative example. Both of filters 2-1 and 2-2 are filters prepared by polymeric nonwoven webs according to Polymeric nonwoven web Preparation Example 2 but have different packing densities, that is, air permeability.

TABLE 2

| | | comparative | | |
|---|---|---|---|---|
| | | example | filter 2-1 | filter 2-2 |
| Polymer Type | | — | polymer B | polymer B |
| Air Permeability (cfm@125 Pa) | | — | 13 | 3 |
| Pore Size (μm) | | — | 1.1 | 0.9 |
| Dust collection | 100 nm | 82.554 | 87.743 | 93.550 |
| Efficiency (%) | 200 nm | 78.238 | 92.270 | 95.140 |
| | 300 nm | 84.937 | 93.550 | 95.176 |

| | | | |
|---|---|---|---|
| Breathing Resistance (mmH₂O) | 5 | 2 | 2 |

Table 3 below shows the air permeability, the dust collection efficiency, and the breathing resistance of the filter 3-1, the filter 3-2, and the filter according to the comparative example. Both of filters 3-1 and 3-2 are filters prepared by polymeric nonwoven webs according to Polymeric nonwoven web Preparation Example 3 but have different packing densities, that is, air permeability.

TABLE 3

| | | comparative | | |
|---|---|---|---|---|
| | | example | filter 3-1 | filter 3-2 |
| Polymer Type | | — | polymer C | polymer C |
| Air Permeability (cfm@125 Pa) | | — | 15 | 4 |
| Pore Size (μm) | | — | 1.8 | 0.9 |
| Dust collection | 100 nm | 82.554 | 84.159 | 91.708 |
| Efficiency (%) | 200 nm | 78.238 | 94.319 | 97.509 |
| | 300 nm | 84.937 | 97.317 | 98.608 |

| | | | |
|---|---|---|---|
| Breathing Resistance (mmH₂O) | 5 | 2 | 3 |

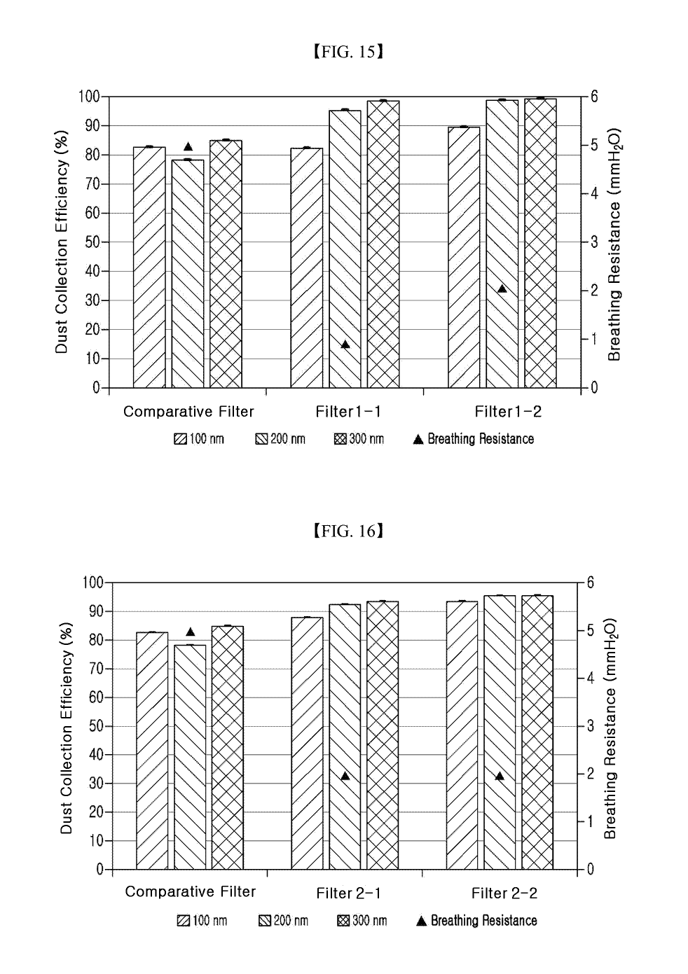

FIG. 15 is a graph showing the dust collection efficiency and the breathing resistance of the filter 1-1, the filter 1-2, and the filter according to the comparative example.

Referring to Table 1 and FIG. 15, the value of the air permeability decreases from the filter 1-1 to the filter 1-2, thereby decreasing the size of the pores. The lower the air permeability, the higher the dust collection efficiency and the pressure drop (ie, the breathing resistance). Filter 1-1 removed 96.401%, 80.687%, and 77.505% of 300 nm, 200 nm, and 100 nm sodium chloride particles, respectively, and the breathing resistance was 1 mmH₂O. Filter 1-2 showed high dust collection efficiencies of more than 90% in 300 nm, 200 nm, and 100 nm sodium chloride particles and showed the low breathing resistance of 4 mmH₂O.

FIG. 16 is a graph showing the dust collection efficiency and the breathing resistance of the filter 2-1, the filter 2-2, and the filter according to the comparative example.

Referring to Table 2 and FIG. 16, the value of the air permeability decreases from the filter 2-1 to the filter 2-2, thereby decreasing the size of the pores. As the air permeability decreased, the dust collection efficiency increased, but the pressure drop (ie, the breathing resistance) was similar. Filter 2-1 removed 93.550/%, 92.270% and 87.743% of 300 nm, 200 nm, and 100 nm sodium chloride particles, respectively, and the breathing resistance was 2 mmH₂O. Filter 2-2 showed high dust collection efficiencies of more than 90% in 300 nm, 200 nm, and 100 nm sodium chloride particles and the breathing resistance was as low as 2 mmH₂O.

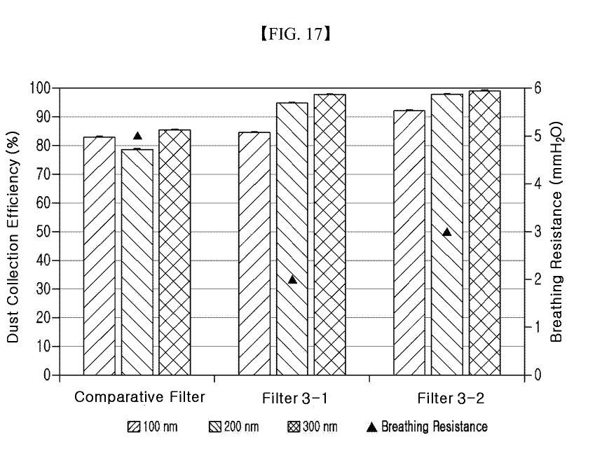

FIG. 17 is a graph showing the dust collection efficiency and the breathing resistance of the filter 3-1, the filter 3-2, and the filter according to the comparative example.

Referring to Table 3 and FIG. 17, the value of the air permeability decreases from the filter 3-1 to the filter 3-2, thereby decreasing the size of the pores. As the air permeability was lowered, the dust collection efficiency became higher, and the pressure drop (that is, the breathing resistance) also increased. Filter 3-1 removed 97.317%, 94.319% and 84.159% of 300 nm, 200 nm, and 100 nm sodium chloride particles, respectively, and the breathing resistance was 2 mmH₂O. Filter 3-2 showed high dust collection efficiencies of more than 90% in 300 nm, 200 nm, and 100 nm sodium chloride particles and the breathing resistance was as low as 3 mmH₂O.

On the other hand, the filter according to the comparative example in Tables 1 to 3 and FIGS. 15 to 17 is a commercially available mask filter having a large fiber diameter of about 2 to 3 μm and a large pore size because it is produced by the melt blown process. Therefore, in order to improve the particle removal efficiency, it is necessary to reduce the size of the pores. For this purpose, the filter manufactured by the melt blown method stacks the fibers thickly (thickness of the filter itself: 110 μm). The filter according to this comparative example exhibited low dust collecting efficiency as compared with the functional polymer nonwoven web according to the present embodiments at all 300 nm, 200 nm, and 100 nm sodium chloride particles, and had a high breathing resistance of 5 mmH₂O.

As described above, the polymer nonwoven web manufactured through the experiments according to the present invention has a high level of dust removal efficiency and a proper level of pressure drop, that is, a breathing resistance. This is because the polymeric nonwoven web is composed of a functional polymer containing an ionic functional group. Specifically, existing filters filter (physically filter) particles larger than the pore size. On the other hand, in the polymeric nonwoven web according to the present embodiment, since the ionic functional group is exposed on the fiber surface, the nonwoven web not only filters particles larger than the pore size, but also filters particles smaller than the pore size if the particles are ionic or charged particles. Such filtering of particles smaller than the pore size is due to the electrostatic attraction between the particles and the ionic functional groups on the fiber surface, which may correspond to chemical filtering.

As described above, particles can be filtered by electrostatic attraction even if the pore size is large compared to the particle size to be filtered. Therefore, the nonwoven web according to the present embodiment can efficiently filter fine particles to a size of 200 nm and further to 100 nm, while not reducing the size of the pores to be smaller than the size of the fine particles. For example, the pore sizes of the filters 1-1 and 1-2 are 1 to 1.5 μm, the pore sizes of the filters 2-1 and 2-2 are 0.9 to 1.1 μm, the pore sizes of the filters 3-1 and 3-2 are 0.9 to 1.8 μm, which were larger than the size of the filtered particles. Also, due to this relatively large pore size, the pressure drop across the filter, i.e., the breathing resistance, may be low.

Thus, the polymeric nonwoven web according to the present embodiments is suitable for use as a respiratory mask filter fabric which can remove ultrafine dust (PM2.5, diameter 2.5 μm) and further ultrafine dust having a diameter less than 1 μm as well as yellow dust, fine dust (PM10, 2.5 μm<diameter≤10 μm).

Example of Antimicrobial Activity Evaluation

The antibacterial properties of the polymeric nonwoven webs A, B, and C obtained through Antimicrobial Polymeric Nonwoven Web Preparation Examples 1, 2 and 3, respectively, were evaluated by the bacterium reduction value according to the KSK0693 standard. Each of Staphylococcus aureus and pneumococci was cultivated for 18 hours in a culture medium itself (control) and a polymeric nonwoven web containing the culture medium, and then the number of viable cells was measured to calculate the antibacterial activity.

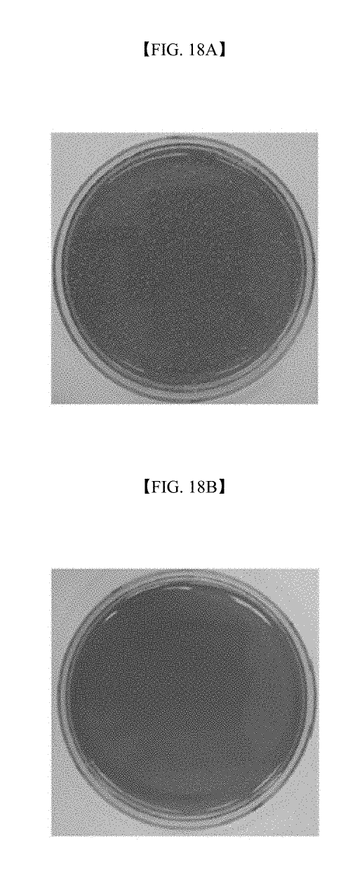

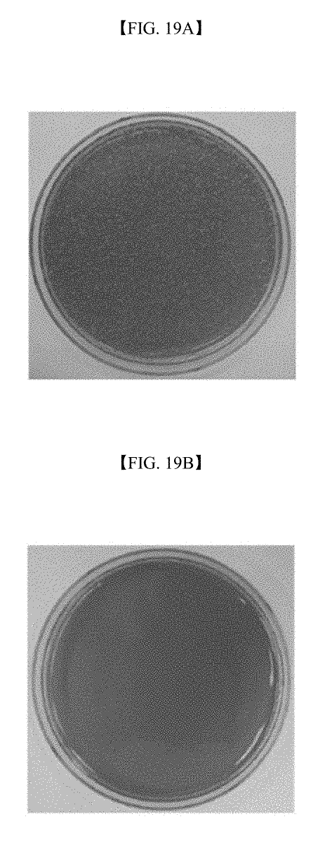

FIGS. 18A and 18B are photographs showing the result of culturing Staphylococcus aureus in the culture medium itself and the polymeric nonwoven web A containing the culture medium, respectively. FIGS. 19A and 19B are photographs showing the result of culturing pneumococci in the culture medium itself and the polymeric nonwoven web A containing the culture medium, respectively.

Referring to FIGS. 18A, 18B, 19A and 19B, it can be seen that the amount of bacteria is very small in the polymeric nonwoven web A (FIGS. 18B and 19B) containing iodine ions according to the example of the present invention.

Specifically, in the polymeric nonwoven web A (FIGS. 18B and 19B) according to the example of the present invention, the antibacterial effect was shown by reducing 99% or more for each of Staphylococcus aureus and Pneumococcus.

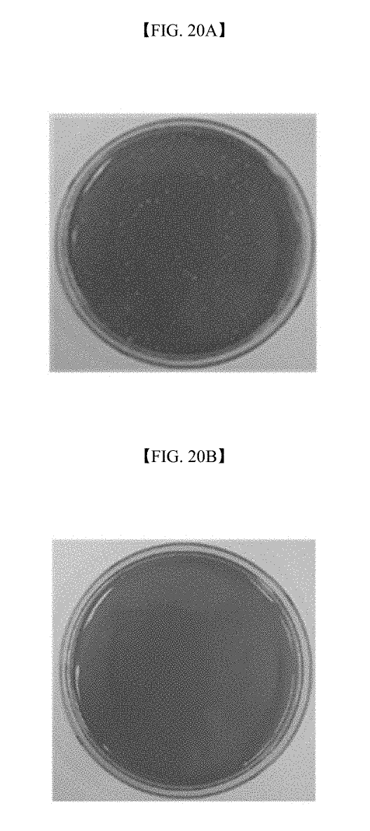

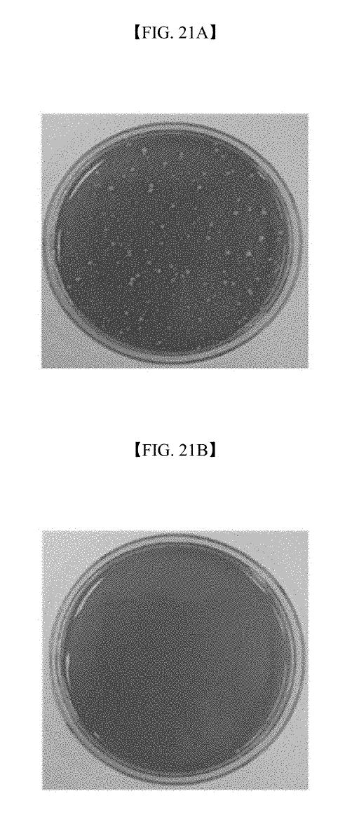

FIGS. 20A and 20B are photographs showing the result of culturing Staphylococcus aureus in the culture medium itself and the polymeric nonwoven web B containing the culture medium, respectively. FIGS. 21A and 21B are photographs showing the result of culturing pneumococci in the culture medium itself and the polymeric nonwoven web B containing the culture medium, respectively.

Referring to FIGS. 20A, 20B, 21A, and 21B, it can be seen that the amount of bacteria is very small in the polymeric nonwoven web B (FIGS. 20B and 21B) containing silver ions according to the example of the present invention. Specifically, in the polymeric nonwoven web B (FIGS. 20B and 21B) according to the example of the present invention, the antibacterial effect was shown by reducing 99.9% or more for each of Staphylococcus aureus and Pneumococcus.

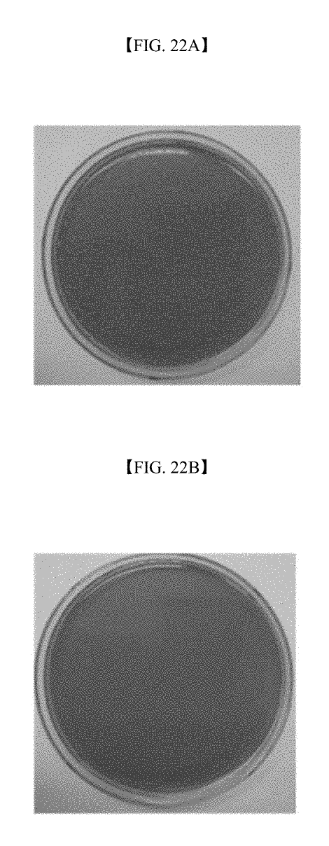

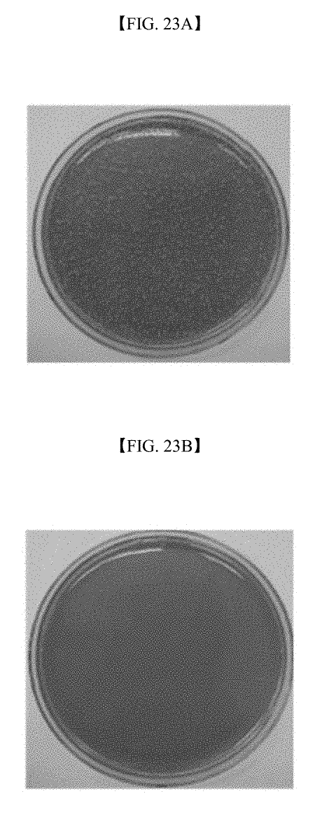

FIGS. 22A and 22B are photographs showing the result of culturing Staphylococcus aureus in the culture medium itself and the polymeric nonwoven web C containing the culture medium, respectively. FIGS. 23A and 23B are photographs showing the result of culturing pneumococci in the culture medium itself and the polymeric nonwoven web C containing the culture medium, respectively.

Referring to FIGS. 22A, 22B, 23A, and 23B, it can be seen that the amount of bacteria is very small in the polymeric nonwoven web C (FIGS. 22B and 23B) containing silver ions according to the example of the present invention.

Specifically, in the polymeric nonwoven web C (FIGS. 22B and 23B) according to the example of the present invention, the antibacterial effect was shown by reducing 99.9% or more for each of Staphylococcus aureus and Pneumococcus.

The present invention is not limited to the above-described embodiments and the accompanying drawings. While the example embodiments of the present invention and their advantages have been described in detail, it should be understood that various changes, substitutions, and alterations may be made herein without departing from the scope of the present invention.

1. A polymeric nonwoven web comprising:
polymer fibers having a diameter in the nanometer range and having a polymer with an ionic functional group in its main chain or side chain.

2. The polymeric nonwoven web of claim 1,
wherein the ionic functional group includes a sulfonate group, an ammonium group, an azanide group, a phosphate group, or a zwitterion group having two of these linked.

3. The polymeric nonwoven web of claim 2,
wherein the ammonium group is a quaternary ammonium group.

4. The polymeric nonwoven web of claim 2,
wherein the ionic functional group including the azanide group is a sulfadiazinyl group.

5. The polymeric nonwoven web of claim 2,
wherein the ionic functional group including the zwitterion group is a phosphorylcholine group.

6. The polymeric nonwoven web of claim 1, further comprising:
Ag⁺ or I⁻ as a counter ion having a charge of opposite sign to the charge of the ionic functional group.

7. The polymeric nonwoven web of claim 1,
wherein the polymer is polystyrene, polymethyl methacrylate, polyarylene ether, polyurethane or a copolymer of two or more thereof.

8. The polymeric nonwoven web of claim 1,
wherein the polymer is a copolymer of a monomer unit having the ionic functional group and a monomer unit having no ionic functional group.

9. The polymeric nonwoven web of claim 8,
wherein the monomers are, independently of each other, styrene-based units, methyl methacrylate-based units, arylene ether-based units, or urethane-based units.

10. The polymeric nonwoven web of claim 1,
wherein the polymer is a polymer represented by the following formula 1: 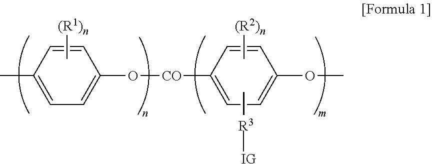
in Formula 1,
n is an integer of 0 to 10000,
m is an integer of 2 to 10000,
l₁ is an integer of 1 to 4,
l₂ is an integer of 1 to 3,
R¹ is, independently of each other, hydrogen, a substituted or unsubstituted C1 to C4 alkyl group, or a substituted or unsubstituted C3 to C12 aryl group,
R² is, independently of each other, hydrogen, a substituted or unsubstituted C1 to C4 alkyl group, or a substituted or unsubstituted C3 to C12 aryl group,
R³ represents a bond, a carbonyl group, a carboxy group, an amide group, a substituted or unsubstituted C1 to C12 alkylene group, a substituted or unsubstituted C1 to C12 alkylenecarbonyl group, a substituted or unsubstituted C1 to C12 carbonylalkylene group, a substituted or unsubstituted C1 to C12 alkylene carboxy group, a substituted or unsubstituted C1 to C12 carboxyalkylene group, a substituted or unsubstituted C1 to C12 alkylene amide group, a substituted or unsubstituted C1 to C12 amide alkylene group, a substituted or unsubstituted C3 to C12 arylene group, a substituted or unsubstituted C3 to C12 arylene carbonyl group, a substituted or unsubstituted C3 to C12 carbonyl arylene group, a substituted or unsubstituted C3 to C12 arylenecarboxy group, a substituted or unsubstituted C3 to C12 carboxyarylene group, a substituted or unsubstituted C3 to C12 arylene amide group, a substituted or unsubstituted C3 to C12 amide arylene group, a substituted or unsubstituted C4 to C12 arylene alkyl group, or a substituted or unsubstituted C4 to C12 alkylene aryl group, and
IG is an ionic functional group including a sulfonate group, a carboxylate group, an ammonium group, an azanide group, a phosphonate group, a phosphate group, or a zwitterion group having two of these combined.

11. The polymeric nonwoven web of claim 1,
wherein the polymer is a polymer represented by the following formula 2: 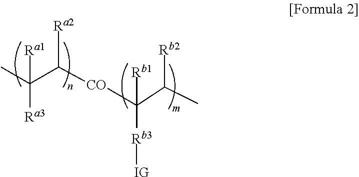
in Formula 2,
n is an integer of 0 to 10000,
m is an integer of 2 to 10000,
R^{a1}, R^{a2}, R^{b1}, and R^{b2} are, independently of each other, hydrogen, a substituted or unsubstituted C1 to C12 alkyl group, or a substituted or unsubstituted C3 to C12 aryl group,
R^{a3} is a substituted or unsubstituted C1 to C12 alkyl group, a substituted or unsubstituted C3 to C12 aryl group, or a substituted or unsubstituted C1 to C12 alkylcarboxy group,
R^{b3} represents a bond, a carbonyl group, a carboxy group, an amide group, a substituted or unsubstituted C1 to C12 alkylene group, a substituted or unsubstituted C1 to C12 alkylenecarbonyl group, a substituted or unsubstituted C1 to C12 carbonylalkylene group, a substituted or unsubstituted C1 to C12 alkylene carboxy group, a substituted or unsubstituted C1 to C12 carboxyalkylene group, a substituted or unsubstituted C1 to C12 alkylene amide group, a substituted or unsubstituted C1 to C12 amide alkylene group, a substituted or unsubstituted C3 to C12 arylene group, a substituted or unsubstituted C3 to C12 arylene carbonyl group, a substituted or unsubstituted C3 to C12 carbonyl arylene group, a substituted or unsubstituted C3 to C12 arylenecarboxy group, a substituted or unsubstituted C3 to C12 carboxyarylene group, a substituted or unsubstituted C3 to C12 arylene amide group, a substituted or unsubstituted C3 to C12 amide arylene group, a substituted or unsubstituted C4 to C12 arylene alkyl group, or a substituted or unsubstituted C4 to C12 alkylene aryl group, and
IG is an ionic functional group including a sulfonate group, a carboxylate group, an ammonium group, an azanide group, a phosphonate group, a phosphate group, or a zwitterion group having two of these combined.

12. The polymeric nonwoven web of claim 1,
wherein the polymer is a polymer represented by the following formula 3: 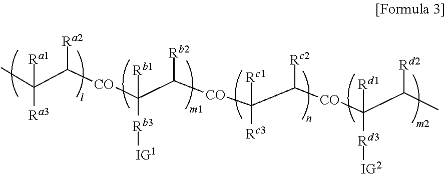
in Formula 3,
l is an integer of 0 to 10000,
n is an integer of 1 to 10000,
m1 and m2 are integers satisfying the condition that m1+m2 is 1 to 10000,
R^{a1}, R^{a2}, R^{b1}, R^{b2}, R^{d1}, R^{c2}, R^{d1}, and R^{d2} are, independently of each other, hydrogen, a substituted or unsubstituted C1 to C12 alkyl group, or a substituted or unsubstituted C3 to C12 aryl group,
R^{a3} and R^{c3} are, independently of each other, a substituted or unsubstituted C1 to C12 alkyl group, a substituted or unsubstituted C3 to C12 aryl group, or a substituted or unsubstituted C1 to C12 alkylcarboxy group,
R^{b3} and R^{d3} represent, independently of each other, a bond, a carbonyl group, a carboxy group, an amide group, a substituted or unsubstituted C1 to C12 alkylene group, a substituted or unsubstituted C1 to C12 alkylenecarbonyl group, a substituted or unsubstituted C1 to C12 carbonylalkylene group, a substituted or unsubstituted C1 to C12 alkylene carboxy group, a substituted or unsubstituted C1 to C12 carboxyalkylene group, a substituted or unsubstituted C1 to C12 alkylene amide group, a substituted or unsubstituted C1 to C12 amide alkylene group, a substituted or unsubstituted C3 to C12 arylene group, a substituted or unsubstituted C3 to C12 arylene carbonyl group, a substituted or unsubstituted C3 to C12 carbonyl arylene group, a substituted or unsubstituted C3 to C12 arylenecarboxy group, a substituted or unsubstituted C3 to C12 carboxyarylene group, a substituted or unsubstituted C3 to C12 arylene amide group, a substituted or unsubstituted C3 to C12 amide arylene group, a substituted or unsubstituted C4 to C12 arylene alkyl group, or a substituted or unsubstituted C4 to C12 alkylene aryl group, and
IG¹ and IG² are, independently of each other, a sulfonate group, a carboxylate group, an ammonium group, an azanide group, a phosphonate group, a phosphate group, or a zwitter ionic group in which two of those ionic groups are bonded.

13. The polymeric nonwoven web of claim 1,
wherein the fibers have a diameter of 100 to 900 nm.

14. The polymeric nonwoven web of claim 1,
wherein the polymeric nonwoven web is a aerosol filter.

15. A process for producing a polymeric nonwoven web comprising:
electrospinning a polymer having an ionic functional group in its main chain or side chain to produce a nonwoven web formed of polymer fibers having a diameter in the nanometer range.

16. The process of claim 15,
wherein the ionic functional group includes a sulfonate group, an ammonium group, an azanide group, a phosphate group, or a zwitterion group having two of these combined.

17. The process of claim 15, further comprising:
immersing the nonwoven web in an ion exchange solution to introduce Ag⁺ or I⁻, which is a counter ion having a charge of opposite sign to the charge of the ionic functional group.

18. A respiratory mask comprising:
a base layer;
a cover layer; And
a polymeric nonwoven web of claim 1 disposed between the base layer and the cover layer.
